(19) United States
(12) Patent Application Publication
(10) Pub. No.: US 2016/0072810 A1
(43) Pub. Date: Mar. 10, 2016

(54) ENTITY-BASED APPLICATION SELECTION/INSTALLATION

(71) Applicant: Microsoft Corporation, Redmond, WA (US)

(72) Inventor: Ananda Sarkar, BELLEVUE, WA (US)

(21) Appl. No.: 14/478,679

(22) Filed: Sep. 5, 2014

(51) Int. Cl. H04L 29/06

(52) U.S. Cl. CPC H04L 63/0884; H04L 63/0853; H04L 63/083

(57) ABSTRACT

In some examples, an entity-based application provision system is described. The entity-based application provision system receives credential information via a client device. Upon verifying the credential information, the entity-based application provision system identifies a corresponding entity type based on the credential information. The entity-based application provision system may then select and install one or more applications that are tailored to the entity type in the client device.

### BACKGROUND ART

With the development of computer technology, computing devices, including laptops, tablets, etc., have been widely used in people's daily lives. A number of organizations, such as enterprises and education institutions, provide computing devices that are shared among users at different times and occasions. These computing devices usually include an excessive number of applications in order to accommodate various needs of the users. For an individual user, this excessive number of applications, however, not only occupies valuable computing resources such as storage and processing power, but also causes difficulty for the user to find and select his/her desired applications from among the excessive number of applications. Furthermore, the preparation of such excessive number of applications in a computing device, such as downloading and installing the applications, could unavoidably incur a huge overhead (e.g., in terms of time and human effort) to the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This application describes example embodiments of entity-based application selection/installation. In one example, a system receives or identifies information of an entity type associated with a user. In response to receiving or identifying the entity type, the system provides one or more applications to a computing device based on the entity type without using information of the user other than the entity type.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example framework for an entity-based application provision system.

FIG. 2 illustrates the example entity-based application provision system in more details.

FIGS. 3A and 3B illustrate example user interfaces provided by the entity-based application provision system or client device.

FIG. 4 illustrates an example setting or login file associated with credential information.

FIG. 5 illustrates an example configuration file associated with an application.

FIG. 6 is a block diagram illustrating an example method of selecting and installing one or more applications for provision to a client device.

### DESCRIPTION OF THE EMBODIMENTS

### Overview

This disclosure includes techniques and arrangements for an entity-based application provision system. The entity-based application provision system automatically determines or selects one or more applications to be provided to a computing device, and provides the one or more applications to the computing device based on an entity type without using other information associated with a user. The entity-based application provision system selects and installs a set of applications that are tailored to a particular entity type (e.g., an entity type associated with one or more users of the computing device, etc.), thus reducing a waste of computing resources, such as storage and processing power, that are occupied by other applications not useful to individual users. Furthermore, by selectively installing a set of applications tailored to a particular entity type, the entity-based application provision system can reduce the time and effort for preparing the applications in the computing device for the user.

In at least one example, the entity-based application provision system may receive or identify information of an entity type for a computing device. The entity-based application provision system may receive the entity type from a user who is responsible for setting up the computing device or a user to whom the computing device is provided or assigned. In some examples, the entity-based application provision system may receive or identify the entity type based on information directly inputted by the user. In an alternative example, the entity-based application provision system may receive or identify the entity type based on credential information that is received from the user. In at least one example, the entity type may include a defined group of users that share or use a same set of applications. By way of example and not limitation, the entity type may include a unit of an organization, e.g., a department of a company or enterprise, an education unit of an education institution, etc.

In response to receiving or identifying the entity type, the entity-based application provision system may select or determine one or more applications based on the entity type. In at least one example, the entity-based application provision system may select or determine the one or more applications based on a mapping between the entity type and the one or more applications.

Upon selecting or determining the one or more applications, the entity-based application provision system may install or load the one or more applications into the computing device. In at least one example, the entity-based application provision system may install or load the one or more applications from a server that stores the one or more applications into the computing device. In some examples, the one or more applications may be pre-stored in memory of the computing device. The entity-based application provision system may load the pre-stored applications from the memory and install the applications in the computing device. The entity-based application provision system may then enable the computing device to provide the one or more applications.

In the examples described herein, the entity-based application provision system identifies an entity type, determines one or more applications based on the entity type, installs the one or more applications into a computing device, and provides the one or more applications via the computing device. In some examples, these functions may be performed by one or more services. For example, an identification service may identify an entity type, while a determination service may determine one or more applications based on the entity type. An installation service may install the one or more applications into a computing device, and a provision service may enable the provision of the one or more applications via the computing device.

Furthermore, although in the examples described herein, the entity-based application provision system may be implemented as software and/or hardware installed in a single device, in other examples, the entity-based application provision system may be implemented and distributed in multiple devices or as services provided in one or more servers over a network and/or in a cloud computing architecture.

The application describes multiple and varied implementations and embodiments. The following section describes an example framework that is suitable for practicing various implementations. Next, the application describes example systems, devices, and processes for implementing an entity-based application provision system.

### Example Framework

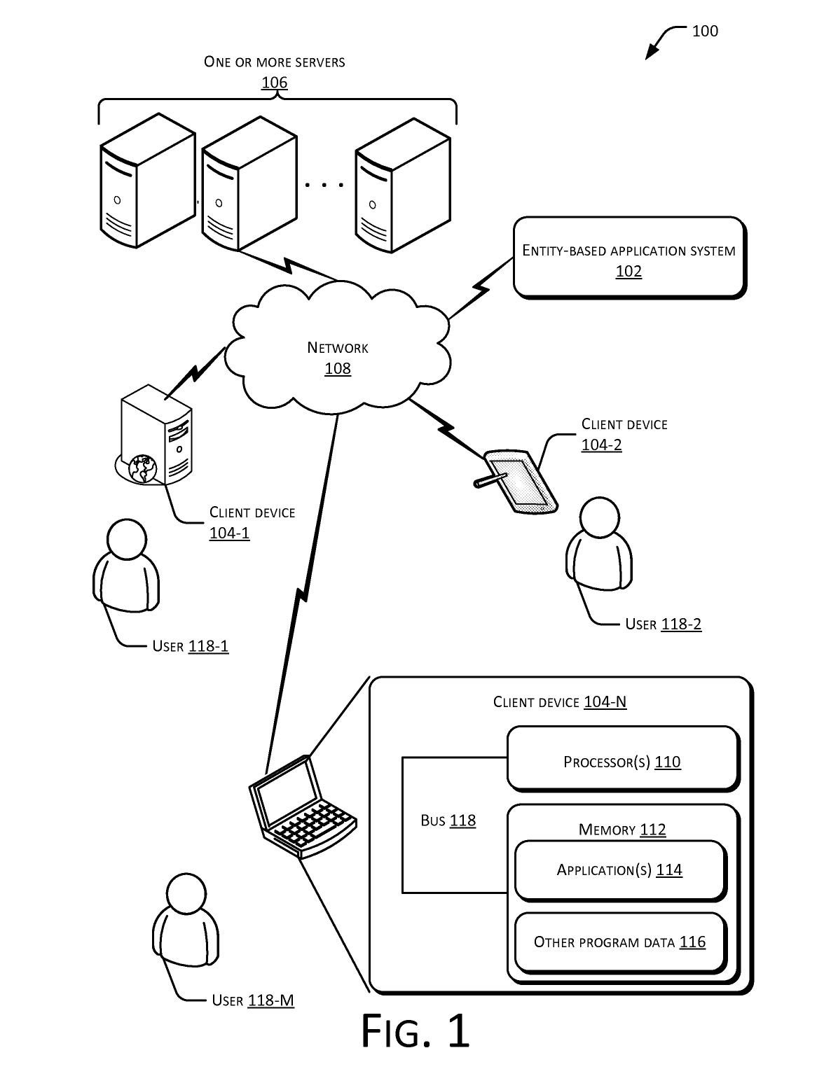

FIG. 1 shows an example framework 100 of an entity-based application provision system 102. In this example, the framework 100 may include one or more client devices 104-1, 104-2, . . . , 104-N (which are collectively referred to as client devices 104) and one or more servers 106. N is an integer greater than zero. The entity-based application provision system 102, the one or more client devices 104 and the one or more servers 106 may communicate data with one another via a network 108.

In this example, the entity-based application provision system 102 is described as an entity separate from the client devices 104 and the servers 106. In other instances, the entity-based application provision system 102 may be distributed among the one or more client devices 104 and/or the one or more servers 106 via the network 108. For instance, the one or more servers 106 may include part of the functions of the entity-based application provision system 102 while other functions of the entity-based application provision system 102 may be included in the one or more client devices 104. Furthermore, in some examples, some or all the functions of the entity-based application provision system 102 may be included in a cloud computing system or architecture.

The client device 104 may be implemented as any of a variety of computing devices. Examples of a computing device may include, for example, a mainframe computer, a server, a notebook or portable computer, a handheld device, a netbook, an Internet appliance, a tablet or slate computer, a mobile device (e.g., a mobile phone, a personal digital assistant, a smart phone, etc.), a gaming console, a set-top box, etc. or a combination thereof.

The server 106 may include files of applications that are to be installed into the client device 104. Additionally or alternatively, the server 106 may include online applications that are run in the server 106 and are accessible remotely by the client device 104 via the network 108.

The network 108 may be a wireless or a wired network, or a combination thereof. The network 108 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof.

In one example, the client device 104 may include one or more processors 110 coupled to memory 112 via a bus 114. In some examples, the bus 114 may include one or more of a system bus, a data bus, an address bus, a PCI bus, a Mini-PCI bus, and any variety of local, peripheral and/or independent buses. The memory 112 may include one or more applications or services 116 and program data 118. The memory 112 may be coupled to, associated with, and/or accessible to other devices, such as network servers, routers, and/or the servers 106.

In some examples, of the environment 100 may further include a plurality of users 120-1, 120-2, . . . , 120-M (collectively referred to as user 120), where M is an integer greater than zero. In at least one example, the user 120 may be a person of an organization (such as an enterprise, an education institution, etc.) who is responsible for assigning and/or configuring the client device 104 for use by other users. Additionally or alternatively, in some examples, the user 120 may include a person who receives or uses the client device 104. By way of example and not limitation, the user 120 may provide entity type information to the client device 104. The entity-based application provision system 102 may determine one or more applications based on the entity type information and provide the one or more applications to the client device 104 without using any user information other than the entity type information, for example.

Although in the example described herein, the client device 104 is described to be a client device shared among multiple users, in some instances, the client device 104 may include a client device of a single user who has one or more entity types, with each entity type corresponding to a respective set of applications tailored thereto. By way of example and not limitation, the user 118 may organize applications according to different divisions (such as home and office), different function types (such as a data search type, a game type, an entertainment type, etc.), different levels of use permissions (such as parent and children), etc. For example, the user 118 may set up an entity type associated with gaming for a client device 104, and select one or more game applications for this gaming entity type. The entity-based application provision system 102 may store a mapping between this gaming entity type and the one or more game applications and provide the one or more game applications to the client device 104 according to the gaming entity type. For another instance, the user 118 may set up a first entity type (such as an entity type for his/her children, etc.), and assign or select a first set of applications for use and/or access by a user of the first entity type. The user 118 may further set up a second entity type (e.g., an entity type for himself/herself), and assign or select a second set of applications for use and/or access by a user of the second entity type, etc.

### Example System

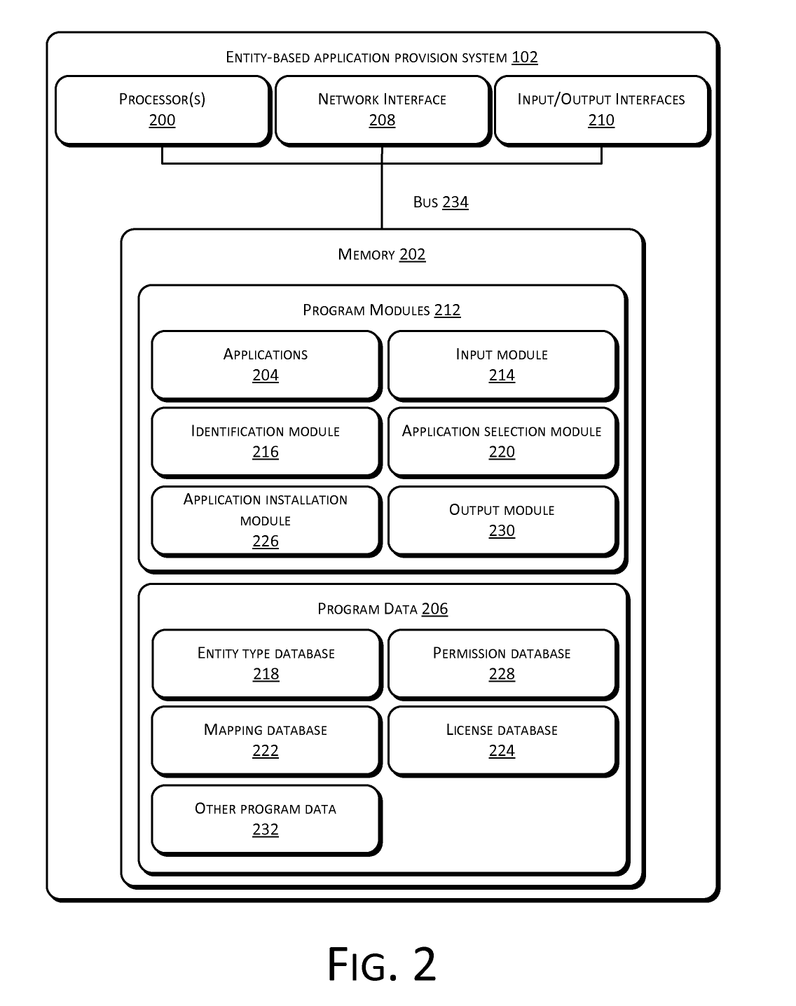

FIG. 2 shows the example entity-based application provision system 102 in more detail. In one example, the entity-based application provision system 102 may include, but is not limited to, one or more processors 200, memory 202, one or more applications or services 204 (e.g., respective applications corresponding to one or more entity types, etc.) and program data 206. In some examples, the entity-based application provision system 102 may further include a network interface 208 and an input/output interface 210. The processor(s) 200 is/are configured to execute instructions received from the network interface 208, received from the input/output interface 210, and/or stored in the memory 202. Additionally or alternatively, some or all of the functionalities of the entity-based application provision system 102 may be implemented using an Application-Specific Integrated Circuit (ASIC), a Field-Programmable Gate Array (FPGA), a System-On-a-Chip system (SOC), a Complex Programmable Logic Device (CPLD) or other hardware.

The memory 202 may include computer-readable media in the form of volatile memory, such as Random Access Memory (RAM) and/or non-volatile memory, such as read only memory (ROM) or flash RAM. The memory 202 is an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. In at least one example, computer storage media may include, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM). Additionally or alternatively, the computer storage media may include, for example, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

In at least one example, the entity-based application provision system 102 may further include program modules 212. In one instance, the entity-based application provision system 102 may include an input module 214, an identification module 216, an entity type database 218, an application selection module 220, a mapping database 222, a license database 224, an application installation module 226, a permission database 228 and an output module 230. In some instances, the entity-based application provision system 102 may further include other program data 232. In at least one example, the other program data 232 may store log data associated with operations of the entity-based application provision system 102 for further analysis and/or troubleshooting, etc.

In some examples, the entity-based application provision system 102 may include a bus 234 that may include, but is not limited to, a system bus, a data bus, an address bus, a PCI bus, a Mini-PCI bus and any variety of local, peripheral and/or independent buses. The bus 234 can operably connect the processor(s) 200, the memory 202, the network interface 208 and/or input/output interfaces with one another.

In at least one example, the input module 214 may receive information from the user 120. The input module 214 may receive the information from the client device 104 of the user 120 via the network 108. By way of example and not limitation, the entity-based application provision system 102 may provide a user interface to the user 120 via a display (not shown) of the client device 104, and enable the user 120 to input or provide the information to the entity-based application provision system 102 via the user interface.

In some examples, the input module 214 may receive the information directly from the user 120. For example, the input module 214 may provide a user interface to the user 120 via the input/output interface 210 (e.g., a touch-sensitive display, a keyboard, etc.), and the user 120 may directly inputs the information via the user interface provided by the input/output interface 210.

In at least one example, the information received from the user 120 may include, but is not limited to, information of one or more entity types, credential information (such as authentication credential, e.g., a username, a password, a user identifier, etc.) that enables the entity-based application provision system 102 to determine or find one or more entity types, etc.

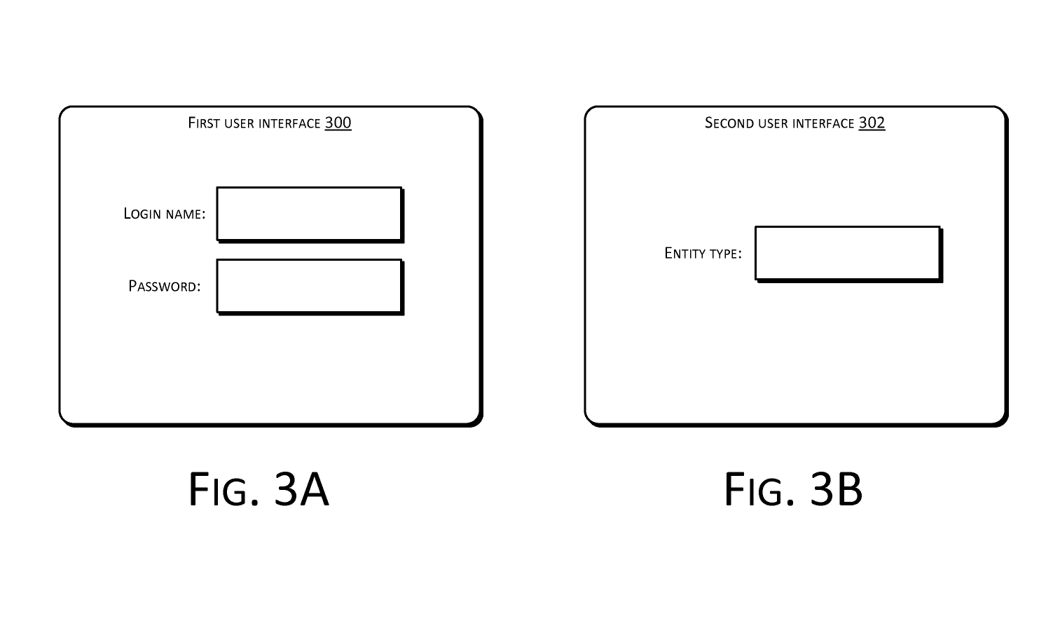

FIGS. 3A and 3B shows two example user interfaces provided by the input module 214 or the client device 104 for the user 120 to input the information. FIG. 3A shows a first user interface 300 that allows the user 120 to input credential information, and FIG. 3B shows a second user interface 302 that allows the user 120 to directly input an entity type. In one instance, the second user interface 302 may include a drop-down list for the user 120 to select an entity type from a list of available entity types provided to and/or via the client device 104.

In some examples, the one or more entity types may be associated with the user 120 or another user for whom the user 120 configures or sets up the client device 104. Examples of an entity type may include a unit or division type of an organization including, for example, a department (such as a sales department, a finance department, etc.) of a company or enterprise, an education unit (such as a class, a department, a class level, a grade level, etc.) of an education institution, etc. Additionally or alternatively, in some examples, the entity type may include a role type associated with a group of users, e.g., a management role associated with a group of managers across different departments of a company or enterprise. Additionally or alternatively, the entity type may include a type of work that is to be done by or assigned to a group of users, e.g., a marketing or education project that is to be done by or assigned to a team of users within a department or across multiple departments of an enterprise or an education institution, etc.

In at least one example, upon receiving the information, an identification module 216 as illustrated in FIG. 2 may identify or determine the one or more entity types based on the received information. For example, if the information received includes explicit information about the one or more entity types, the identification module 216 may directly identify or determine the one or more entity types based on this information.

In other instances, if the information received includes credential information, the identification module 216 may deduce or derive the information of the one or more entity types based on the credential information. In some examples, the identification module 216 may verify the validity of the credential information, and identify or determine the one or more entity types from the credential information upon successful verification. In at least one example, the identification module 216 may identify or determine the entity type based on entity type information included in the credential information.

In some examples, the identification module 216 may identify or determine the one or more entity types based on a setting or login file associated with the credential information. For example, upon successful verification of the credential information received, the identification module 216 may retrieve a setting or login file associated with the credential information. The identification module 216 may read information about the one or more entity types from the setting or login file.

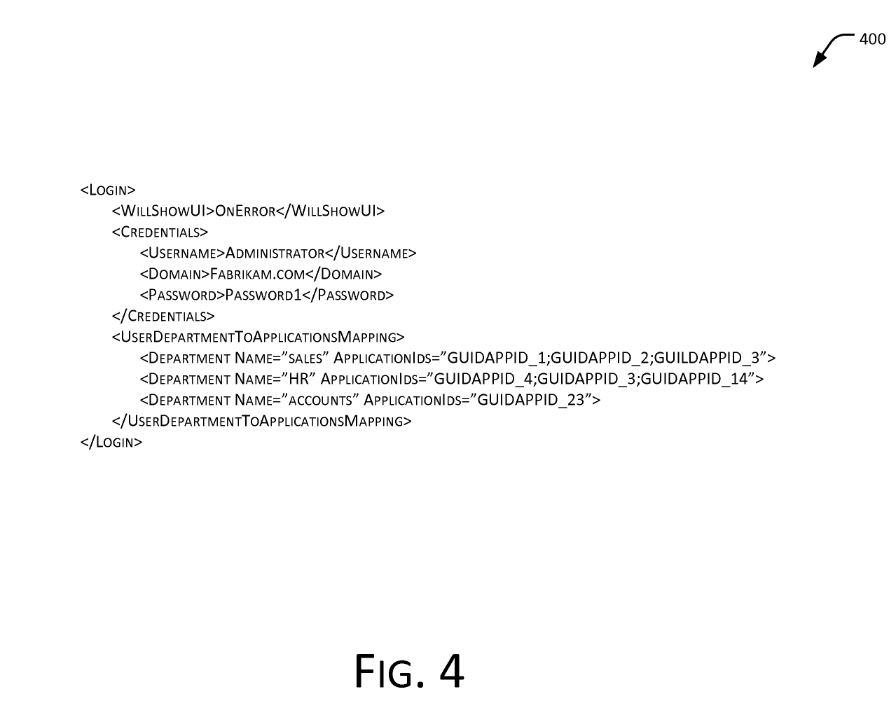

FIG. 4 illustrates an example setting or login file 400 associated with credential information. In this example, the setting or login file is written or presented in XML (eXtensible Markup Language) format. However, in other instances, the setting or login file may be written in other types of format, such as HTML (HyperText Markup Language), plain text, etc., provided that rules, tags and/or keywords have been designated to enable the identification module 216 to recognize information in the setting or login file. In FIG. 4, an example of a special tag, i.e., <UserDepartmentToApplicationsMapping> is used for signaling a presence of a mapping between an entity type and an application. In this example, information of entity types are placed under this special tag with names (or “Department Name” in FIG. 4) as “sales”, “HR”, and “accounts”.

Additionally or alternatively, the identification module 216 as illustrated in FIG. 2 may identify or determine the entity type based on a mapping between the entity type and the credential information. For example, the identification module 216 may search the entity type from an entity type database 218, as illustrated in FIG. 2, which stores a schema or mapping between the entity type and the credential information. In some examples, the credential information may be associated with a profile that is stored in the entity type database 218, for example. The identification module 216 may retrieve the profile associated with the credential information from the entity type database 218 upon successful verification.

In some examples, after identifying or receiving the information of the entity type, an application selection module 220 as illustrated in FIG. 2 may determine or identify one or more applications to be provided to the client device 104. In at least one example, the application selection module 220 may determine or identify the one or more applications based on the entity type, for example, based on the entity type only. In one instance, the application selection module 220 may determine or identify the one or more applications without using or receiving user information other than the entity type. In at least one example, the application selection module 220 may identify or determine the one or more applications from the setting or login file. For example, FIG. 4 shows identifiers of respective one or more applications corresponding to an entity type. In this example, applications with identifiers (i.e., “ApplicationIds” in FIG. 4) as “GUIDAPPID_1”, “GUIDAPPID_2”, and “GUIDAPPID_3” are associated with an entity type “sales”.

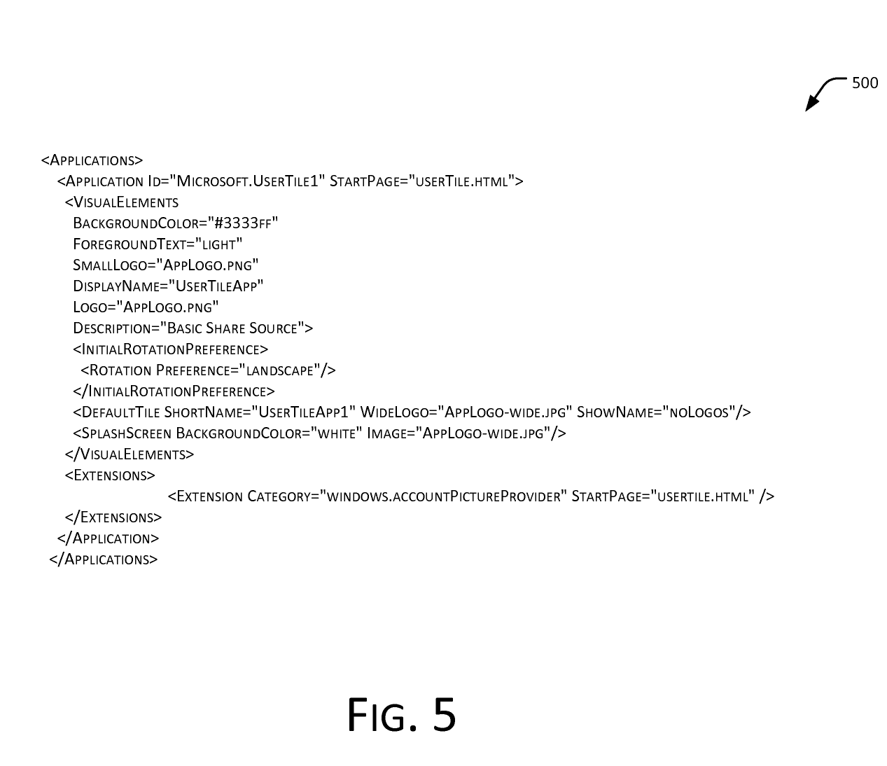

FIG. 5 shows a configuration file 500 of an application. In this example, the configuration file 500 is written in XML. However, in other instances, the configuration file 500 may be written in other formats, such as HTML format, plain text format, etc. “Microsoft.UserTitle1” under an “Application Id” tag represents an identifier of the application in this example.

Additionally or alternatively, the application selection module 220 as illustrated in FIG. 2 may identify or determine the one or more applications based on a mapping between the one or more applications and the entity type. For example, the application selection module 220 may obtain information of this mapping from a mapping database 222, as illustrated in FIG. 2, which stores mappings between entity types and applications.

In some examples, the application selection module 220 may identify or determine the one or more applications by receiving further information from the user 120 via the input module 214 as illustrated in FIG. 2. For example, the user 120 may be a person responsible or authorized for selecting or setting up the one or more applications for the entity type. The application selection module 220 may provide a user interface that displays a number of applications available to the user 120 for selection. The number of available applications may include, for example, applications that the organization has purchased and/or obtained licenses thereof, applications that are available for purchase by the user 120 or the organization, etc. The application selection module 220 may obtain information of the available applications by querying a license database 224, as illustrated in FIG. 2, which stores information of the licensed and/or purchased applications of the organization, for example.

In at least one example, the application selection module 220 may provide the user interface to the client device 104 or the input/output interface 210 for display to the user 120, and receive information of the one or more applications selected by the user 120 via the user interface. The application selection module 220 may store information of a relationship or mapping between the entity type and the one or more applications in the setting file and/or the mapping database 222. In some examples, the application selection module 220 may store the information of the relationship or mapping between the entity type and the one or more applications in the memory of the client device 104. Additionally or alternatively, an operating system of the client device 104 may store the information of the relationship or mapping between the entity type and the one or more applications in the memory of the client device 104 in response to receiving an instruction from the application selection module 220.

In some examples, the application selection module 220 may further identify or determine the one or more applications based on a device type of the client device 104. By way of example and not limitation, some applications, such as a spreadsheet application, may be available to one device type (e.g., a desktop or laptop computer, etc.) but may not be available to another device type (such as a mobile phone, etc.). In at least one example, the application selection module 220 may identify or determine the one or more applications that are available to a particular device type by querying the license database 224, for example.

Upon identifying or determining the one or more applications for the entity type, an application installation module 226 as illustrated in FIG. 2 may prepare the one or more applications for provision to the client device 104. In at least one example, the application installation module 226 may determine whether the one or more applications have been made available to the client device 104 for the user 118 or the entity type previously. For example, the user 120 or a user of the entity type may use or log into the client device 104 previously and the application installation module 226 may have already installed or made available the one or more applications to the client device 104 in response to such previous use or login.

In some examples, the application installation module 226 may determine whether the one or more applications have been made available to the client device 104 for provision to the user 120 or a user of the entity type by querying the mapping database 222, for example. In at least one example, besides storing the mapping or relationship between the entity type and the one or more applications, the mapping database 222 may further store a record indicating which entity type has been or is currently configured for which device, e.g., the client device 104. The application installation module 226 may query the mapping database 222 to determine whether the entity type associated with the client device 104 exists in the record. In response to detecting that the entity type has been configured for the client device 104, the application installation module 226 may determine that the one or more applications associated with the entity type have been made available to the client device 104. The application installation module 226 may therefore provide the one or more available (e.g., installed) applications to the user 120 associated with the entity type via the client device 104.

In some examples, the application installation module 226 may determine that the client device 104 has not been configured for the entity type. By way of example and not limitation, the application installation module 226 may determine that the client device 104 has not been configured for the entity type when the entity type is received or identified for the client device 104 for the first time. Additionally or alternatively, the application installation module 226 may determine that the client device 104 has not been configured for the entity type when the user 120 (or a user of the entity type) logs in the client device 104 for the first time, etc. In response to determining that the client device 104 has not been configured for the entity type, the application installation module 226 may prepare the one or more applications for provision to the client device 104.

In some examples, depending on where the one or more applications are stored and/or whether the one or more applications are to be installed into the client device 104, the application installation module 226 may prepare the provision of the one or more applications to the client device 104 differently. By way of example and not limitation, in an event that the one or more servers 106 stores an application of the one or more applications, the application installation module 226 may enable the client device 104 to download the application from the one or more servers 106. The application installation module 226 may then instruct the client device 104 to install the application for use by a user having the entity type, e.g., the user 120.

In some examples, the one or more applications may include an online or remote application. The application installation module 226 may instruct the one or more servers 106 to enable the client device 104 to access and/or use the online application that is run by and/or in the one or more servers 106 via the network. For example, the application installation module 226 may instruct the one or more servers 106 to store a record indicating that the client device 104 is authorized to access and/or use the online application provided by the one or more servers 106 when a user (e.g., the user 120) of the client device 104 corresponds to the entity type. In at least one example, in an event that the client device 104 stores an application of the one or more applications, the application installation module 226 may instruct the client device 104 to load the application and provide the application in the client device 104 for use by a user having the entity type.

Additionally, in some examples, the application installation module 226 may further set up or determine one or more permissions, such as permissions for security and/or functionalities associated with the one or more applications based on the entity type. By way of example and not limitation, the application installation module 226 may allow a user of a first entity type (e.g., a sales department of an enterprise) to read and modify financial data using a spreadsheet application. The application installation module 226 may, however, allow another user of a second entity type (e.g., a personnel department of the enterprise) to read the data using the spreadsheet application only.

In at least one example, the application installation module 226 may set up the one or more permissions for the one or more applications based on the entity type with an instruction from the user 120. For example, the user 120 may be a person responsible or authorized for defining permissions for the one or more applications. The application installation module 226 may receive an instruction about how to set up the permissions for the one or more applications in advance, for example, and store information of the permissions in a permission database 228 as illustrated in FIG. 2. Upon identifying or receiving the information of the entity type and determining the one or more applications to be provided, the application installation module 226 may retrieve or obtain respective permission information for the one or more applications from the permission database 228. The application installation module 226 may then set up the permissions for the one or more applications to be used via or in the client device 104 accordingly. By way of example and not limitation, the application installation module 226 may send the permission information of the one or more applications to the client device 104 through an output module 230, and instruct the client device 104 to enforce the permissions of the one or more applications with respect to the entity type. Additionally or alternatively, in some examples, when the one or more applications are online applications provided from the one or more servers, the application installation module 226 may send the permission information of the one or more applications to the one or more servers 106 and instruct the one or more servers 106 to enforce the permissions accordingly.

Regardless of whether the application installation module 226 sets up the permissions for the one or more applications, the application installation module 226 may enable the provision of the one or more applications to the client device 104 according to the entity type received or identified through the foregoing operations of the application installation module 226. The user 120 or a user associated with the entity type for which the client device is configured may use the one or more applications via the client device 104.

Furthermore, after the one or more applications have been provided to the client device 104 according to the entity type, the client device 104 may provide the one or more applications in subsequent detection or identification of the entity type. For example, the user 120 may use the one or more applications repeatedly in subsequent use or login of the client device 104. For example, the client device 104 may provide the one or more applications for the entity type in subsequent use or login by a user of the entity type without the entity-based application provision system 102 repeating the foregoing operations, e.g., selection and installation of the one or more applications, etc. In at least one example, the entity-based application provision system 102 or the client device 104 may search or retrieve the relationship or mapping between the entity type and the one or more applications from a relevant storage location. Examples of the relevant storage location may include, for example, the setting file or the mapping database 222, etc., that is associated with or accessible by the entity-based application provision system 102 or the client device 104. If such relationship or mapping between the entity type and the one or more applications exists, the entity-based application provision system 102 or the client device 104 may enable the user 120 to use or access the one or more applications in or via the client device 104.

In some instances, the client device 104 may receive or identify a new entity type (e.g., when the client device 104 may be assigned to another user, etc.) at a later time or occasion. The entity-based application provision system 102 may determine or identify the new entity type as described in the foregoing operations. In an event that the entity-based application provision system 102 determines or identifies that the client device 104 has previously been configured for this new entity type, the entity-based application provision system 102 may determine the one or more applications based on the relationship or mapping between the new entity type and the one or more applications. Upon determining the one or more applications, the entity-based application provision system 102 may enable the client device 104 to provide the one or more applications based on the new entity type.

In some instances, rather than the entity-based application provision system 102 determining or identifying whether the client device 104 has been configured for this new entity type, the client device 104 performs such determination or identification using information, such as credential information, provided for determining the new entity type. In an event of determining or identifying that the client device 104 has been configured for this new entity type, the client device 104 may determine the one or more applications associated with the new entity type based on the relationship or mapping (e.g., in the setting file) stored in the memory of the client device 104. The client device 104 may then provide the one or more applications, which have been made available to the client devices previously, based on the new entity type.

In some examples, if the entity-based application provision system 102 or the client device 104 determines that the client device 104 has not been configured for the new entity type, the entity-based application provision system 102 may determine respective one or more applications for the new entity type as described above. The entity-based application provision system 102 may then install or make available this one or more applications to the client device 104 based on the new entity type received.

### Example Methods

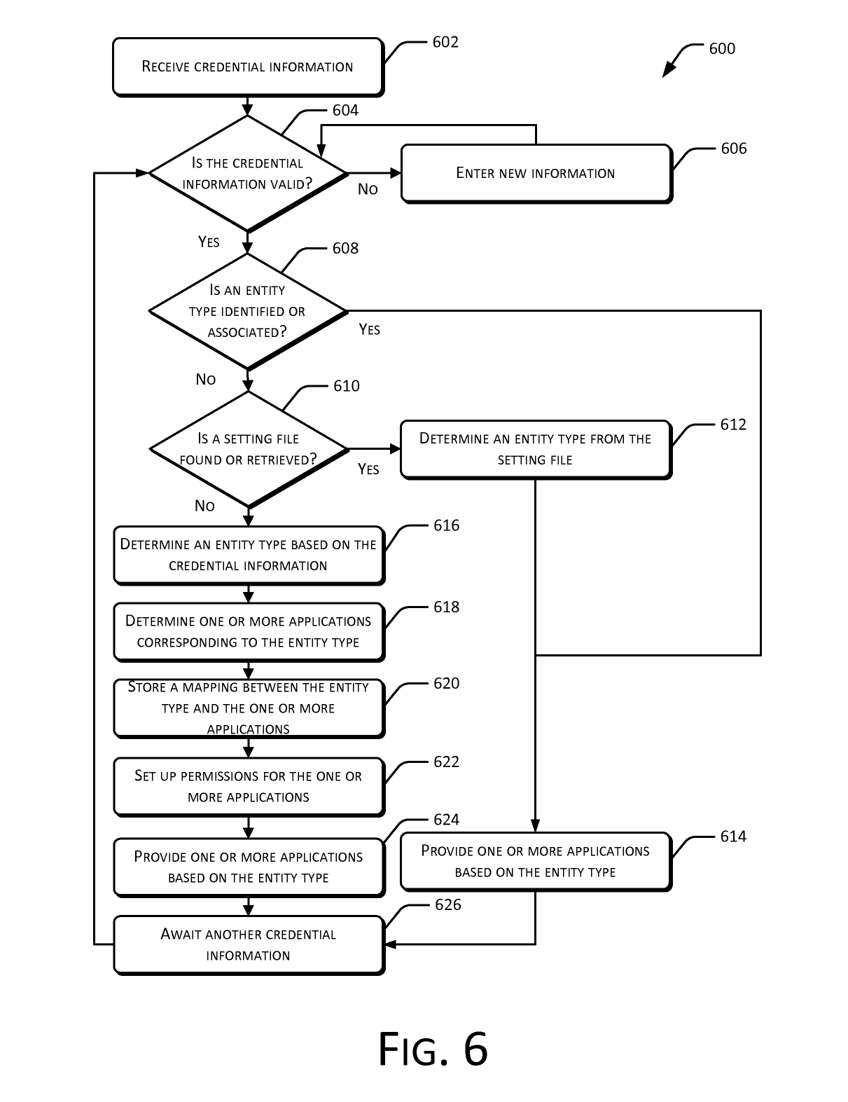

FIG. 6 is a flow chart depicting an example method 600 of selecting and installing one or more applications to a client device. The method of FIG. 6 may, but need not, be implemented in the environment of FIG. 1, using the device of FIG. 2, user interfaces of FIGS. 3A and 3B, and/or setting or configuration files of FIGS. 4 and 5. For ease of explanation, method 600 is described with reference to FIGS. 1-5. However, the method 600 may alternatively be implemented in other environments and/or using other systems.

Method 600 is described in the general context of computer-executable instructions. Generally, computer-executable instructions can include routines, programs, objects, components, data structures, procedures, modules, functions, and the like that perform particular functions or implement particular abstract data types. The method can also be practiced in a distributed computing environment where functions are performed by remote processing devices that are linked through a communication network. In a distributed computing environment, computer-executable instructions may be located in local and/or remote computer storage media, including memory storage devices.

The example method is illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

At block 602, the entity-based application provision system 102 and/or the client device 104 may receive information, such as credential information and/or an authentication credential, etc., from the user 120.

At block 604, the entity-based application provision system 102 and/or the client device 104 may verify the validity of the credential information. In some instances, the client device 104 may send the credential information to the entity-based application provision system 102 for verification.

At block 606, if verification fails, the entity-based application provision system 102 and/or the client device 104 may prompt the user 120 to enter new information, and may verify the new information received from the user 120.

At block 608, during or upon successful verification of the credential information, the entity-based application provision system 102 and/or the client device 104 may identify or determine whether an entity type is associated with the credential information. By way of example and not limitation, the entity-based application provision system 102 and/or the client device 104 may query or retrieve the entity type associated with the credential information from a database that stores the credential information and/or additional information associated with the credential information within the entity-based application provision system 102, the client device 104 and/or the one or more servers 106. Examples of the additional information may include, but is not limited to, an entity type associated with a user corresponding to the credential information, etc.

At block 610, upon successful verification of the credential information, the entity-based application provision system 102 and/or the client device 104 may determine whether a setting file associated with the credential information exists. For example, the entity-based application provision system 102 and/or the client device 104 may determine or query whether a setting file associated with the credential information exists in the entity-based application provision system 102, the client device 104 and/or the one or more servers 106.

At block 612, the entity-based application provision system 102 and/or the client device 104 determines that the setting file associated with the credential information exists locally in the entity-based application provision system 102 and/or the client device 104. In some embodiments, the entity-based application provision system 102 may determine that the setting file associated with the credential information exists remotely in the one or more servers 106, and retrieve the setting file from the one or more servers 106. The entity-based application provision system 102 and/or the client device 104 may then determine or retrieve an entity type associated with the user 120 from the setting file.

At block 614, the entity-based application provision system 102 and/or the client device 104 provides one or more applications based on the entity type. For example, the entity-based application provision system 102 and/or the client device 104 loads the one or more applications from the memory of the client device 104 or connects the client device 104 to the one or more servers 106 where the one or more applications are located and run. The entity-based application provision system 102 and/or the client device 104 thus enables the user 120 to access and use the one or more applications.

At block 616, in an event that no setting file associated with the credential information exist, the entity-based application provision system 102 and/or the client device 104 determines or identifies the entity type based on the information, e.g., the credential information, received.

At block 618, upon determining or identifying the entity type of the user 120, the entity-based application provision system 102 and/or the client device 104 determines one or more applications corresponding to the entity type. For example, the entity-based application provision system 102 or the client device 104 may determine or identify the entity type associated with the user 120 by querying the mapping database 222 and/or receiving information of selection of the one or more applications from the user 120.

At block 620, the entity-based application provision system 102 or the client device 104 stores a relationship or mapping between the entity type and the one or more applications in the client device 104.

At block 622, the entity-based application provision system 102 or the client device 104 may set up respective permissions for the one or more applications based on the entity type.

At block 624, the entity-based application provision system 102 or the client device 104 provides the one or more applications for use or access according to the entity type. For instance, the entity-based application provision system 102 or the client device 104 may cause installation of the one or more applications to the client device 104. In some instances, the entity-based application provision system 102 or the client device 104 may enable the client device 104 to connect to the one or more servers 106 and access the one or more applications provided remotely from the one or more servers 106.

At block 626, the entity-based application provision system 102 or the client device 104 awaits credential information from and/or of the same user or another user to process provision of applications to the same user or the other user via the client device 104 as described in the foregoing blocks.

### Example Clauses

A: A method comprising: identifying an entity type for which one or more applications are to be provided to a client device without using information about a user other than the entity type; and providing the one or more applications to the client device based at least in part on the entity type.

B: A method as paragraph A recites, wherein the entity type comprises a type associated with at least one of a department in an enterprise or an educational unit in an education institution.

C: A method as either paragraph A or paragraph B recites, wherein the entity type comprises a type associated with a role or work task assigned to a group of users.

D: A method as any one of paragraphs A-C recites, wherein providing the one or more applications comprises causing installation of the one or more applications to the client device.

E: A method as any one of paragraphs A-D recites, wherein providing the one or more applications comprises enabling access to at least one installed application for the user in the client device according to the entity type.

F: A method as any one of paragraphs A-E recites, wherein the one or more applications are provided to the client device without receiving the information of the user other than the entity type.

G: A method as any one of paragraphs A-F recites, further comprising determining a mapping based at least in part on the entity type, wherein the one or more applications are provided based at least in part on the mapping.

H: A method as any one of paragraphs A-G recites, further comprising: receiving authentication credential of the user; and determining the entity type of the user based at least in part on the authentication credential of the user.

I: A method as paragraph H recites, wherein determining the entity type of the user comprises: retrieving a setting file associated with the authentication credential upon successful verification of the authentication credential of the user; and obtaining information of the entity type of the user from the setting file.

J: A method as any one of paragraphs A-I recites, further comprising determining or retrieving respective one or more security permissions associated with the one or more applications based at least in part on the entity type.

K: A method as paragraph J recites, wherein providing the one or more applications comprises providing the one or more applications with the respective one or more security permissions.

L: One or more computer-readable media having computer-executable instructions thereon, the computer-executable instructions to configure a computer to perform a method as any one of paragraphs A-L recites.

M: A device comprising: one or more processors and one or more computer-readable media having computer-executable instructions thereon to configure the device to perform a method as any one of paragraphs A-L recites, the one or more processors adapted to execute the computer-executable instructions to perform the method as any one of paragraphs A-L recites.

N: A computing device comprising: one or more processors; computer-readable media storing executable instructions that, when executed by the one or more processors, cause the one or more processors to perform acts comprising: receiving credential information of a user; determining whether the memory stores a setting file associated with the credential information of the user, the setting file including information of an entity type of the user; in response to determining that the memory stores the setting file, retrieving the information of the entity type of the user; and providing one or more applications tailored to the entity type without using information of the user other than the entity type.

O: A computing device as paragraph N recites, wherein the entity type comprises a type associated with at least one of a department in an enterprise or an educational unit in an education institution.

P: A computing device as either paragraph N or paragraph O recites, wherein the entity type comprises a type associated with a role or work task assigned to a group of users.

Q: A computing device as any one of paragraphs N-P recites, the acts further comprising verifying validity of the credential information of the user prior to determining whether the memory stores the setting file associated with the credential information of the user.

R: A computing device as any one of paragraphs N-Q recites, the acts further comprising determining or retrieving respective one or more security permissions associated with the one or more applications based at least in part on the entity type.

S: A computing device as any one of paragraphs R recites, wherein providing the one or more applications comprises providing the one or more applications with the respective one or more security permissions.

T: A computing device as any one of paragraphs N-S recites, wherein providing the one or more applications comprises causing installation of the one or more applications to the computing device.

U: A computing device as any one of paragraphs N-T recites, wherein providing the one or more applications comprises enabling access to at least one installed application for the user in the computing device according to the entity type.

V: A computing device as any one of paragraphs N-U recites, wherein the one or more applications are provided to the client device without receiving the information of the user other than the entity type.

W: A computing device as any one of paragraphs N-V recites, the acts further comprising determining a mapping based at least in part on the entity type, wherein the one or more applications are provided based at least in part on the mapping.

X: One or more computer-readable media storing executable instructions that, when executed by one or more processors, cause the one or more processors to perform acts comprising: identifying information of an entity type of a user; and providing one or more applications to a client device based at least in part on the entity type without using information of the user other than the entity type.

Y: One or more computer-readable media as paragraph X recites, wherein providing the one or more applications comprises causing installation of the one or more applications to the client device.

Z: One or more computer-readable media as either paragraph X or paragraph Y recites, wherein providing the one or more applications comprises: enabling access to an installed application for the user in the client device according to the entity type; and/or enabling access to an application that is run in a server via the client device.

AA: One or more computer-readable media as any one of paragraphs X-Z recites, the acts further comprising: receiving authentication credential of the user; and determining the entity type of the user based at least in part on the authentication credential of the user.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more system(s) and/or device(s) 102, 104, 106 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A computer-implemented method comprising:
identifying an entity type for which one or more applications are to be provided to a client device without using information about a user other than the entity type; and
providing the one or more applications to the client device based at least in part on the entity type.

2. The computer-implemented method as recited in claim 1, wherein the entity type comprises a type associated with at least one of a department in an enterprise or an educational unit in an education institution.

3. The computer-implemented method as recited in claim 1, wherein the entity type comprises a type associated with a role or work task assigned to a group of users.

4. The computer-implemented method as recited in claim 1, wherein providing the one or more applications comprises causing installation of the one or more applications to the client device.

5. The computer-implemented method as recited in claim 1, wherein providing the one or more applications comprises enabling access to at least one installed application for the user in the client device according to the entity type.

6. The computer-implemented method as recited in claim 1, wherein the one or more applications are provided to the client device without receiving the information of the user other than the entity type.

7. The computer-implemented method as recited in claim 1, further comprising determining a mapping based at least in part on the entity type, wherein the one or more applications are provided based at least in part on the mapping.

8. The computer-implemented method as recited in claim 1, further comprising:
receiving authentication credential of the user; and
determining the entity type of the user based at least in part on the authentication credential of the user.

9. The computer-implemented method as recited in claim 8, wherein determining the entity type of the user comprises:
retrieving a setting file associated with the authentication credential upon successful verification of the authentication credential of the user; and
obtaining information of the entity type of the user from the setting file.

10. The computer-implemented method as recited in claim 1, further comprising determining or retrieving respective one or more security permissions associated with the one or more applications based at least in part on the entity type.

11. The computer-implemented method as recited in claim 10, wherein providing the one or more applications comprises providing the one or more applications with the respective one or more security permissions.

12. A computing device comprising:
one or more processors;
computer-readable media storing executable instructions that, when executed by the one or more processors, cause the one or more processors to perform acts comprising:
receiving credential information of a user;
determining whether the memory stores a setting file associated with the credential information of the user, the setting file including information of an entity type of the user;
in response to determining that the memory stores the setting file, retrieving the information of the entity type of the user; and
providing one or more applications tailored to the entity type without using information of the user other than the entity type.

13. The computing device as recited in claim 12, wherein the entity type comprises:
a type associated with at least one of a department in an enterprise or an educational unit in an education institution; or
a type associated with a role or work task assigned to a group of users.

14. The computing device as recited in claim 12, the acts further comprising verifying validity of the credential information of the user prior to determining whether the memory stores the setting file associated with the credential information of the user.

15. The computing device as recited in claim 12, the acts further comprising determining or retrieving respective one or more security permissions associated with the one or more applications based at least in part on the entity type.

16. The computing device as recited in claim 15, wherein providing the one or more applications comprises providing the one or more applications with the respective one or more security permissions.

17. One or more computer-readable media storing executable instructions that, when executed by one or more processors, cause the one or more processors to perform acts comprising:
identifying information of an entity type of a user; and
providing one or more applications to a client device based at least in part on the entity type without using information of the user other than the entity type.

18. The one or more computer-readable media as recited in claim 17, wherein providing the one or more applications comprises causing installation of the one or more applications to the client device.

19. The one or more computer-readable media as recited in claim 17, wherein providing the one or more applications comprises:
enabling access to an installed application for the user in the client device according to the entity type; and/or
enabling access to an application that is run in a server via the client device.

20. The one or more computer-readable media as recited in claim 17, the acts further comprising:
receiving authentication credential of the user; and
determining the entity type of the user based at least in part on the authentication credential of the user.
